(19) United States
(12) Patent Application Publication
(10) Pub. No.: US 2007/0011641 A1
(43) Pub. Date: Jan. 11, 2007

(54) Semiconductor integrated circuit device

(76) Inventor: Ryota Nishikawa, Osaka (JP)

Correspondence Address: MCDERMOTT WILL & EMERY LLP, 600 13TH STREET, N.W., WASHINGTON, DC, 20005-3096, US

(21) Appl. No.: 11/482,792

(22) Filed: Jul. 10, 2006

(30) Foreign Application Priority Data
Jul. 11, 2005 (JP) P2005-201899

(51) Int. Cl. G06F 17/50

(52) U.S. Cl. 716/14

(57) ABSTRACT

The semiconductor integrated circuit device includes a plurality of grid-like wiring structures 150 arranged as unit regions in an entire circuit area and having the same shape as a clock wiring structure, respectively; a first wiring structure in which the wiring paths from an clock input 110 to the respective grid-like wiring structures 150 are connected with substantially equal lengths and a common buffer circuit 120 or buffer circuits with the same kind and the same number of stages and clock gating circuits 140 are inserted in the same order in the respective wiring paths; and a second wiring structure connecting a clock synchronizing circuit to the grid-like wiring structure with the shortest length in each unit region. The clock is gate-controlled by a clock control signal separately supplied to the clock gating circuit.

### BACKGROUND OF THE INVENTION

1. Field of the Invention

This invention relates to a semiconductor integrated circuit device capable of realizing minimization of clock skew and low power consumption.

2. Description of the Related Art

In a large-scaled semiconductor integrated circuit device, problematic is a propagation delay time difference (clock skew) of a clock signal on a wiring path from a clock supply point to a clock input of a clock synchronizing circuit gate such as a flip-flop operating in synchronism with the clock supplied. Increased clock skew makes it impossible to operate the semiconductor integrated circuit device at a high speed. Therefore, in a conventional semiconductor integrated circuit device, as a wiring structure for supplying the clock to the clock synchronizing circuit gate, using an equal-length branched wiring structure with H-shapes and grid-like wiring structures represented by mesh-like wirings composed of orthogonally crossing wirings, a clock supplying path is formed, thereby reducing the clock skew (for example, see JP-A-6-244282 (Page 4, FIG. 4)).

On the other hand, the percentage occupied by the power consumed by clocks in the power consumed inside the semiconductor integrated circuit device becomes larger than the electric power consumed by other signal wirings. Therefore, reducing the clock power consumption by clocks is one of effective methods for realizing the low power consumption in the semiconductor integrated circuit device. The conventional semiconductor integrated circuit device is provided with the grid-like wiring structures for each of function modules and a device for supplying/stopping the clock according to the activation/deactivation of the function module on the clock supplying paths to the grid-like wiring structures (for example, see JP-A-2003-109382 (Page 12, FIG. 1, FIG. 2)).

The clock wiring structure disclosed in Patent Reference 1 is excellent as a technique for reducing the clock skew. However, in the clock supply to the grid-like wring structures, the entire wiring length of the clock wirings is very long, and the clock supply to each the grid-like wiring structures is always executed. This gives rise to a problem that the power consumption by clocks is greatly increased.

The clock wiring structure disclosed in JP-A-2003-109382 (Page 12, FIG. 1, FIG. 2) can reduce the clock skew within the function module and power consumption by clocks. However, the wiring lengths from the clock input in the semiconductor integrated circuit device to the grid-like wiring structures of the function modules are different, thereby giving a tendency of increasing the clock skew. This semiconductor integrated circuit device is provided with the grid-like wiring structure corresponding to the size of each the function modules so that the wiring structure with substantially equal wiring lengths cannot be realized. In such a wiring structure, the reduction of the clock skew is limited thereby to present a problem of restraining the high speed operation of the semiconductor integrated circuit device.

As described above, the conventional semiconductor integrated circuit device has a limit in the aspect of reducing the clock skew and power consumption by clocks. So it is difficult to operate the semiconductor integrated circuit device at a high speed by reduction of the clock skew and reduce the power consumption in the semiconductor integrated circuit device.

### SUMMARY OF THE INVENTION

An object of this invention is to provide a semiconductor integrated circuit device capable of minimizing the clock skew and reducing power consumption by a clock signal.

The semiconductor integrated circuit device according to this invention includes a plurality of grid-like wiring structures arranged as unit regions in an entire circuit area and having the same shape as clock wiring structures, respectively; a first wiring structure in which the wiring paths from a single clock input to the respective grid-like wiring structures are connected with substantially equal lengths and a common circuit or circuits with the same kind and the same number of stages are inserted in the same order in the respective wiring paths; and a second wiring structure connecting a clock synchronizing circuit such as a flip-flop to each the grid-like wiring structures with the shortest length in each unit region, wherein the circuits inserted in the first wiring structure include at least one stage of buffer circuit and at least one stage of clock gating circuit whose clock is gate-controlled by a clock control signal.

In accordance with the above configuration, since the entire circuit area of the semiconductor integrated circuit device is constructed of an arrangement of unit regions having similar grid-like wiring structures, also in the semiconductor integrated circuit device where the function modules or controlled regions having various sizes are mixed, the connection by the first wiring structure giving substantially equal wiring lengths can be realized regardless of these function modules or controlled regions so that the clock skew can be minimized. In addition, by appropriately gate-controlling the clock gating circuits by the clock control signal, the power consumption by the clock signal can be reduced.

In this invention, the first wiring structure is formed as an equal-length branched wiring structure with H-shapes. In accordance with this configuration, by the equal-length branched wiring structure with the H-shapes, the equal-length wirings on the respective wiring paths from the single clock input to the grid-like wiring structures can be easily realized. In addition, while keeping the equal wiring lengths, a common circuit or circuits with the same kind and the same number of stages are inserted in the same order in the respective wiring paths.

In this invention, the clock control signal is given for each of the unit regions, for each of regions each composed of the plurality of unit regions, or each of function modules each composed of the plurality of unit regions. In accordance with this configuration, the clock control signals for gate-controlling the clock gating circuits can be given many combination. Therefore, by controlling the supply/stop of the clock signal according to the configuration of the semiconductor integrated circuit device and its operating state, the power consumption by the clock signal can be reduced most effectively.

In this invention, the clock gating circuit located at the final stage of the circuits inserted in the first wiring structure clock gate-controls for each of the unit regions. In accordance with this configuration, since at least one stage of clock gating circuit is given for each of the unit regions, the combination of the clock control signals capable of fully reducing the power consumption by the clock signal can be made according to the configuration of the semiconductor integrated circuit device.

In this invention, the clock gating circuit located at the final stage of the circuits inserted in the first wiring structure clock gate-controls simultaneously for the plurality of unit regions. In accordance with this configuration, since the clock is gate-controlled simultaneously for the plurality of unit regions, by reducing the number of the clock gating circuits according to the configuration of the semiconductor integrated circuit device and effectively controlling the supply/stop of the clock signal as a whole, the power consumption by the clock signal can be effectively reduced.

In this invention, the grid-like wiring structures have the same physical shape in all of the unit regions. In accordance with this configuration, the load capacities of the grid-like wiring structures are uniform so that the clock skew by the second wiring structure can be minimized.

In accordance with this invention, also in the semiconductor integrated circuit device where the function modules or controlled regions having various sizes are mixed, the connection by the first wiring structure giving substantially equal wiring lengths can be easily realized so that the clock skew can be minimized. Further, since the supply/stop of the clock signal can be optionally controlled by gate-controlling the clock gating circuit, the power consumption by the clock signal can be reduced.

For the reason described above, the operation time of the product for mobile use such as a cellular phone for which the semiconductor integrated circuit device with high performance is required can be lengthened. In addition, owing to the reduced power consumption, the semiconductor integrated circuit device according to this invention can be applied to the use of the household electric appliances having little effect on the environment other than the products for the mobile use.

### BRIEF DESCRIPTION OF THE DRAWINGS

FIG. 1 is a view showing the clock wiring structure in the semiconductor integrated circuit device according to the first embodiment of this invention.

FIG. 2 is a detailed view of a connection portion between a clock gating circuit and grid-like wirings.

FIG. 3 is a view showing an exemplary of the construction of the clock gating circuit and its operation.

FIG. 4 is a view showing the clock wiring structure having buffer gates at a plurality of stages inserted in a first wiring structure in the semiconductor integrated circuit device according to the first embodiment of this invention.

FIG. 5 is a view showing the clock wiring structure having buffer gates at a plurality of stages inserted in a first wiring structure in the semiconductor integrated circuit device according to the first embodiment of this invention.

FIG. 6 is a view showing the clock wiring structure where the semiconductor integrated circuit device according to the first embodiment of this invention is composed of a plurality of function modules.

FIG. 7(a) is a view showing the clock wiring structure in the semiconductor integrated circuit device according to a second embodiment of this invention.

FIG. 7(b) is a view showing the clock wiring structure in the semiconductor integrated circuit device according to the second embodiment of this invention.

FIG. 7(c) is a view showing the clock wiring structure in the semiconductor integrated circuit device according to the second embodiment of this invention.

FIG. 7(d) is a view showing the clock wiring structure in the semiconductor integrated circuit device according to the second embodiment of this invention.

FIG. 8(a) is a view showing the clock wiring structure where the semiconductor integrated circuit device according to the second embodiment of this invention is composed of a plurality of function modules.

FIG. 8(b) is a view showing the clock wiring structure where the semiconductor integrated circuit device according to the second embodiment of this invention is composed of a plurality of function modules.

FIG. 9 is a view for explaining the three-dimensional shape of the grid-like wiring structure in a unit region.

### DESCRIPTION OF THE PREFERRED EMBODIMENTS

Now referring to the drawings, an explanation will be given of various preferred embodiments of this invention. In the semiconductor integrated circuit device according to this invention, first, the entire circuit area is constituted by an arrangement of unit regions having grid-like wiring structures with the same shape in a clock wiring structure, thereby realizing a clock wiring structure and circuit means for minimizing the clock skew and reducing the power consumption by a clock signal.

### Embodiment 1

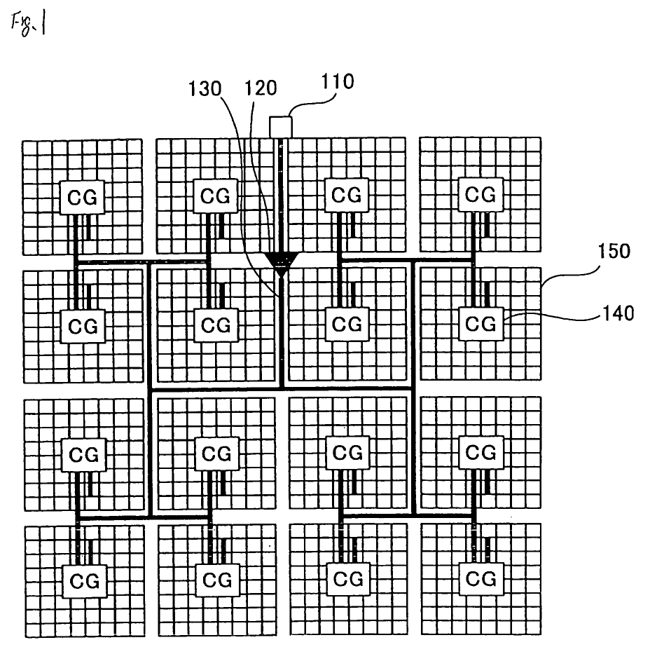

FIG. 1 is a view showing the clock wiring structure of a semiconductor integrated circuit device according to the first embodiment of this invention. In FIG. 1, reference numeral 110 denotes a clock input to the semiconductor integrated circuit device; 120 a buffer gate which is a buffer circuit serving as a clock driver; 130 a first wiring structure; 140 one of clock gating circuits; and 150 one of grid-like wiring structures in the unit regions.

The first wiring structure 130 is a wiring structure in which the clock input 110 is connected to a plurality of grid-like wiring structures 150 with equal wiring lengths. In FIG. 1, the clock input 110 is connected to the clock inputs to the clock gating circuits 140 located in the plurality of grid-like wiring structures with substantially equal wiring lengths by an equal-length branched wiring structure with H-shapes via the buffer gate 120 inserted on the way of wiring paths. The outputs from the clock gating circuits 140 are directly connected to the grid-like wiring structures 150, respectively.

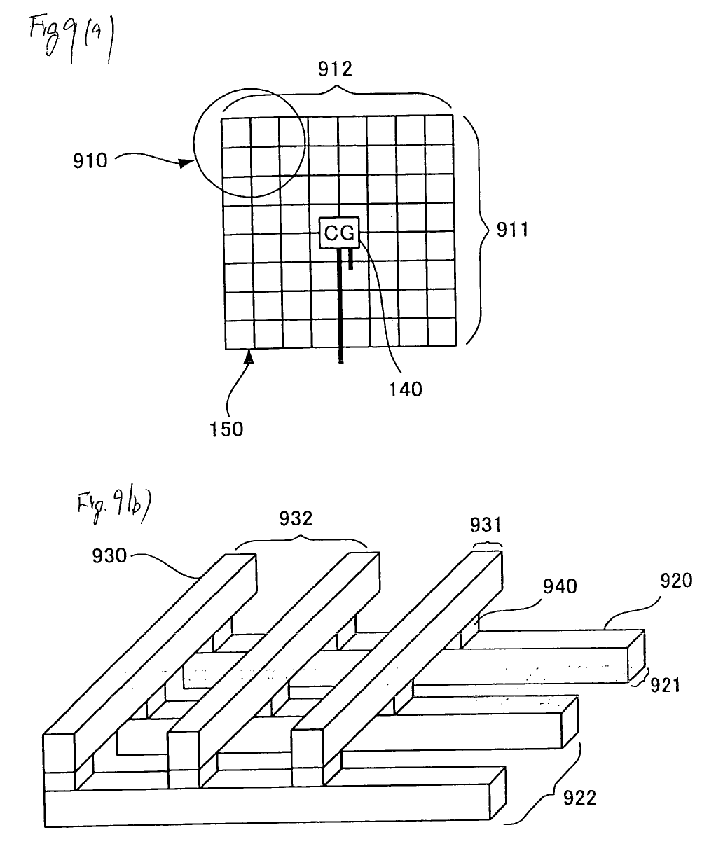

FIG. 9 is a view for explaining the three-dimensional shape of a grid-like wiring structure 150 in a unit region. The unit region shown in FIG. 9(a) has the grid-like wiring structure 150 having the same shape of a clock wiring structure, in which the clock gating circuit 140 is located on a symmetrical center line, and the number 911 of horizontal wirings and the number 912 of vertical wirings are constant, respectively.

FIG. 9(b) is a view three-dimensionally showing a part 910 encircled by a circle in the grid-like wiring structure 150 in FIG. 9(a). In FIG. 9(b), horizontal wirings 920 and vertical wirings 930 arranged in respective wiring layers are connected with each other by through-holes 940, thereby constituting the grid-like wiring structure 150. In this case, the wiring width 921 of each the horizontal wirings 920 and the interval 922 therebetween are fixed. Likewise, the wiring width 931 of each the horizontal wirings 930 and the interval 932 therebetween are also fixed.

In this way, using the same number of vertical wirings and horizontal wirings, the grid-like wiring structure with the equal wiring widths and equal wiring intervals is formed so that the capacitance of each grid-like wiring structure is made uniform and the load capacitance for a clock driving circuit is also made uniform, thereby reducing the clock skew.

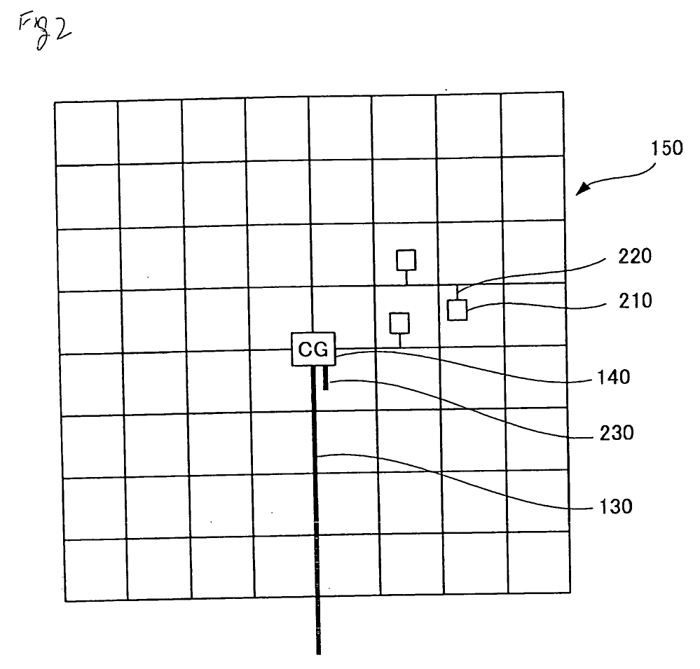

FIG. 2 is a view showing in detail a connecting portion between the clock gating circuit 140 and the grid-like wiring structure 150. In FIG. 2, reference numeral 210 denotes a clock synchronizing circuit gate such as a flip-flop. Its clock input is connected to the grid-like wiring structure 150 through a second wiring structure 220.

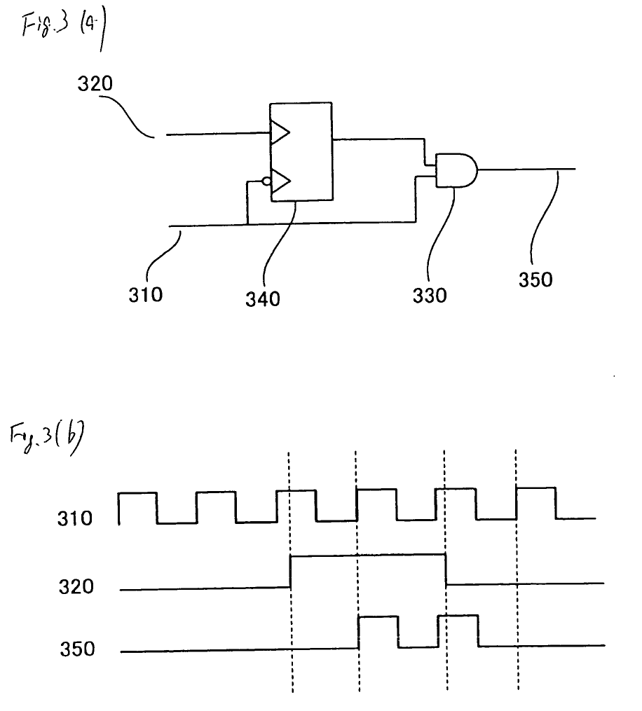

The clock gating circuit 140 has a gate control function, and gate-controlled by a clock control signal 230, thereby executing the supply/stop of clocks for the grid-like wiring structure 150. FIG. 3(a) is a circuit diagram showing a typical example of the construction of the clock gating circuit 140. FIG. 3(b) is a waveform chart for explaining the operation of the clock gating circuit 140.

Referring to FIG. 3, the clock gating circuit 140 has a clock input 310, an input 320 of the clock control signal 230 and an clock output 350. The clock gating circuit 140 further has a latch circuit 340 for synchronization and an AND gate 330 for gate control. The clock signal from the clock input 310 is gate-controlled according to the state of the input 320 of the clock control signal so that the clock for the clock output 350 is supplied or stopped.

It should be noted that such a gating circuit is a known technique and so does not specify the circuit configuration in this invention.

In the embodiment constructed as described above, the clock skew occurring owing to the differences in the wiring lengths from the grid-like wiring structure 150 to the clock synchronizing gates 210 is identical to the clock skew occurring in the conventional grid-like wiring structure.

As regards the first wiring structure 130, the wiring lengths from the clock input 110 to the plurality of grid-like wiring structures 150 are substantially equal, and the logic gates through the clock passes are the buffer gate 120 and the clock gating circuit 140. Namely, the kind and number of stages of the logic gates through the clock passes are the same so that the delay times of the clock propagated from the clock input 110 to the plurality of grid-like wiring structures 150 are substantially equal, thereby substantially minimizing the clock skew.

Each of the plurality of grid-like wiring structures 150 is provided with the clock gating circuit 140, respectively. So, by inputting the clock control signal 230, the supply/stop of the clock to the grid-like wiring structure 150 can be controlled, thereby effectively reducing the power consumption by clocks.

In this embodiment, the first wiring structure 130 was constructed as the equal-length branched wiring structure with the H-shapes. However, as long as the clock input 110 can be connected to the plurality of grid-like wiring structures 150 with the substantially equal lengths, the wiring structure having the other shape may be used to realize the semiconductor integrated circuit device which can satisfy the sprit of this invention.

Meanwhile, in the configuration shown in FIG. 1, the buffer gate 120 at the one stage is connected to all the clock gating circuits 140. However, as the semiconductor integrated circuit is large-scaled to increase the number of the grid-like wiring structures 150, the number of the clock gating circuits 140 is also increased. As a result, only the clock driver by the buffer gate 120 at the one stage will lead to a problem of increasing the propagation delay time of the clock.

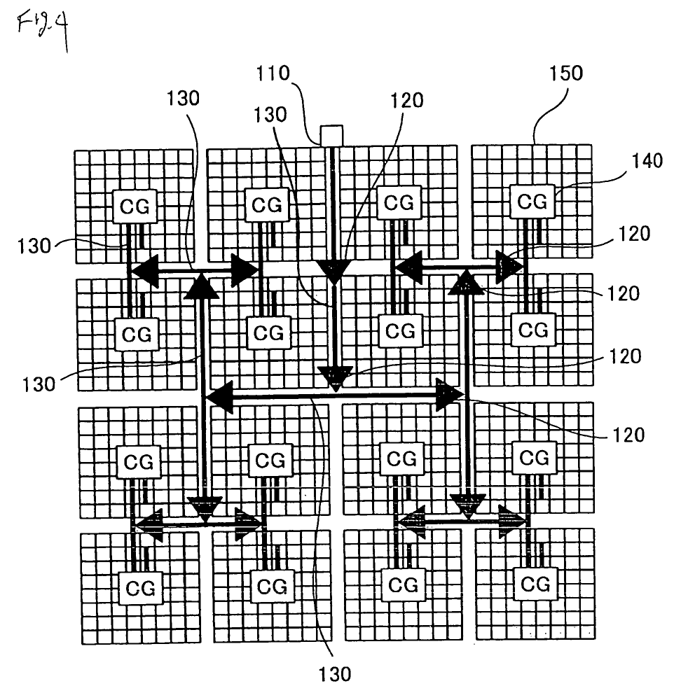

FIG. 4 shows an example of the clock wiring structure when a plurality of stages of buffer gates 120 are inserted in the first wiring structure 130 as a countermeasure for solving the above problem. In FIG. 4, the buffer gates 120 at five stages are inserted between the clock input 110 and the plurality of clock gating circuits 140.

In this case, after the wiring path of the first wiring structure 130 has been first branched, the buffer gates 120 inserted in the continuing wiring path are preferably located at physically symmetrical positions and symmetrically arranged. For example, as shown in FIG. 4, if they are located at the branching points, their arrangement is physically symmetrical and the lengths of the wirings connecting the respective buffer gates 120 can be made substantially equal.

It should be noted that the number of the plurality of stages of buffer gates 120 to be inserted in the first wiring structure 130 can be flexibly determined according to the conditions such as the scale, performance and designing process of the semiconductor integrated circuit device.

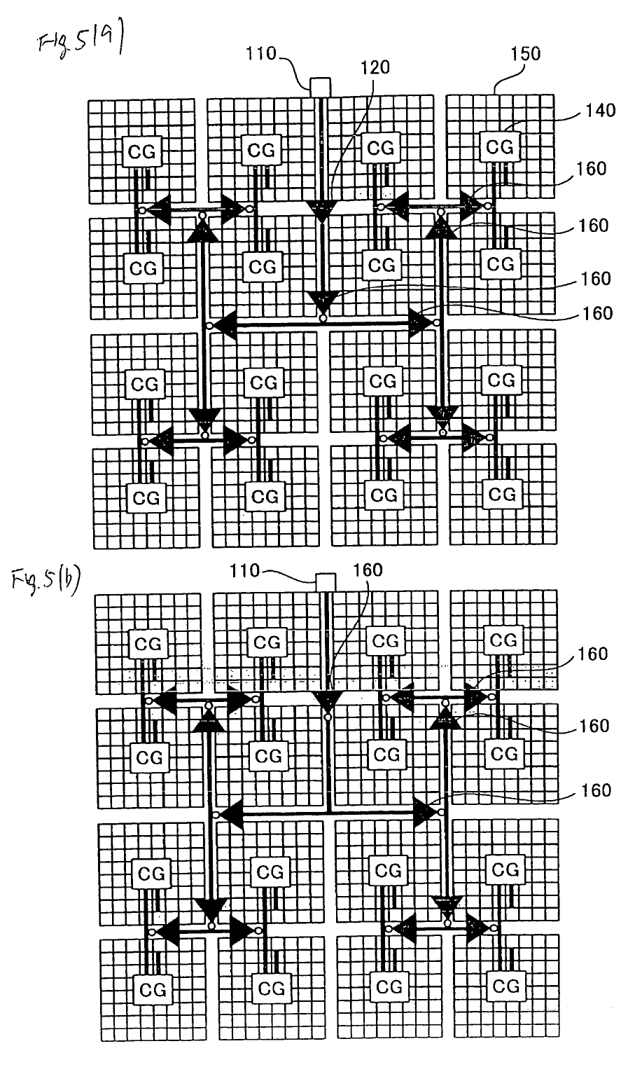

FIG. 5 is a view showing an example using inverter circuits as the buffer circuits for the clock driver to be inserted into the first wiring structure 130. In the first wiring structure shown in FIG. 5(a), except the buffer gate 120 initially located on the wiring path in FIG. 4, all the other buffer gates 120 are replaced by the inverter circuits 160. In the first wiring structure shown in FIG. 5(b), all the buffer gates 120 in FIG. 4 are replaced by the inverters 160.

In addition to the examples of the constructions shown in FIG. 5, as occasion demands, some of the buffer gates 120 in FIG. 4 may be replaced by the inverter circuits 160. Incidentally, where the inverter circuits are employed, a combination of the inverter circuit and the buffer gate is selected so that the clock signal in phase with the clock input 110 can be propagated to the clock gating circuits 140, for example, the number of stages of the inverter circuits from the clock input 110 to the clock gating circuits 140 is made always an even number.

By adopting the inverter circuits as described above, regardless of the scale of the semiconductor integrated circuit device, the propagation delay time of the clock from the clock input 110 to the grid-like wiring structure 150 can be shortened thereby to minimize the clock skew.

In the above explanation, the entire circuit area was explained as a single function module. However, actually, the semiconductor integrated circuit device generally consists of a plurality of function modules. In this case also, if the circuit region of each function module is constructed of an arrangement of unit regions each having the grid-like wiring structure with the same shape in their clock wiring structure, by adopting the above first wiring structure, the effect of this embodiment can be obtained.

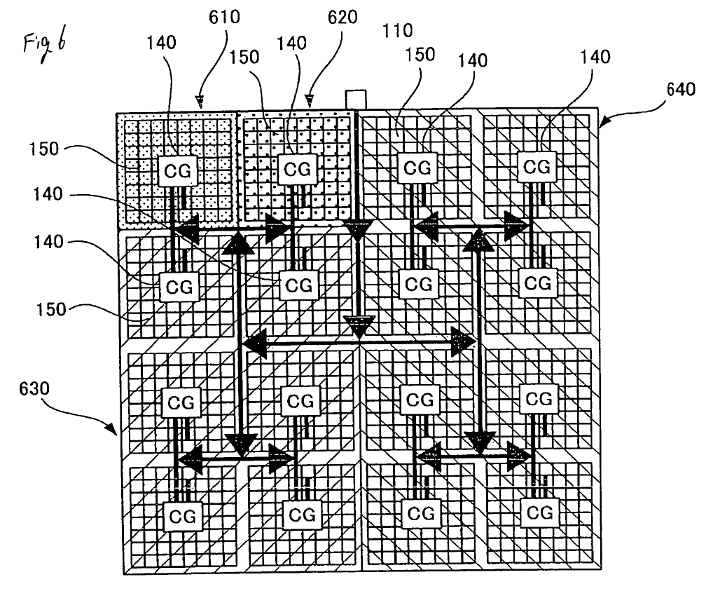

FIG. 6 is a view showing an application example of this embodiment in the semiconductor integrated circuit device consisting of a plurality of function modules. In FIG. 6, reference numerals 610 and 620 denote the function module of a single unit region having the grid-like wiring structure 150, respectively.

Reference numeral 630 denotes the function module consisting of six unit regions each having the grid-like wiring structure 150. Reference numeral 640 denotes the function module consisting of eight unit regions each having the grid-like wiring structure 150.

In comparison between the configuration of the semiconductor integrated circuit device shown in FIG. 6 and that of the semiconductor integrated circuit device shown in FIG. 4, in FIG. 4, the entire circuit area consists of the single function module whereas in FIG. 6, it consists of four function modules 610, 620, 630 and 640.

However, since the four function modules 610, 620, 630 and 640 are constructed of an arrangement of the unit regions each having the grid-like wiring structure 150, the entire wiring structure of the semiconductor integrated circuit device can adopt the same first wiring structure 130 as that in FIG. 4.

The supply and stop of the clock in each function module can be realized by the gate control by the clock control signal 230 in the clock gating circuit(s) 140 in the grid-like wiring structure(s) 150 of the unit region(s) constituting each function module.

### Embodiment 2

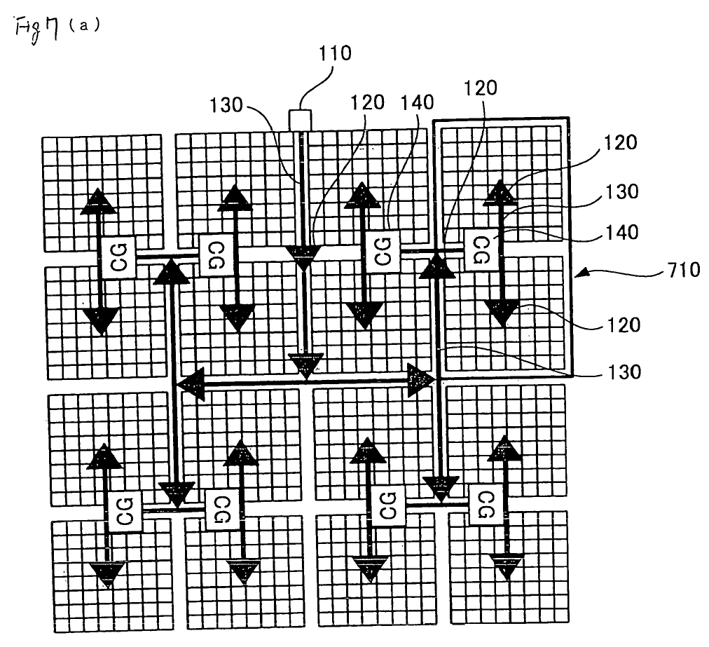

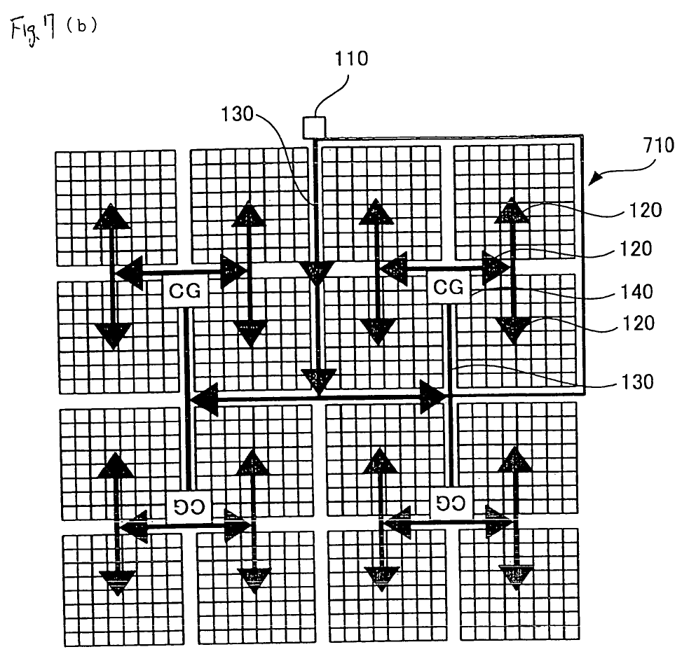

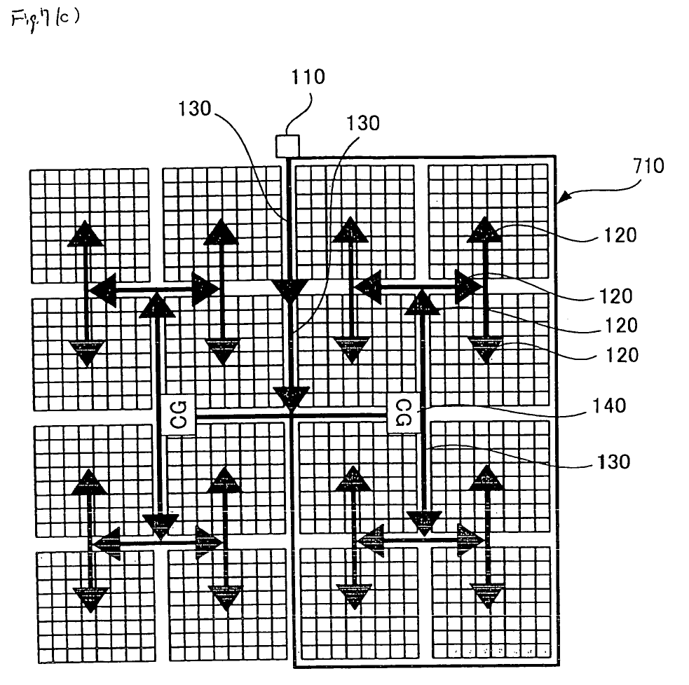

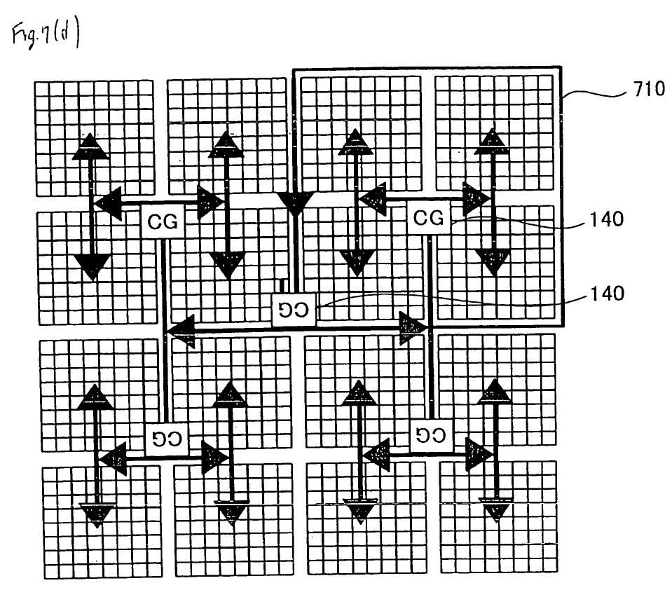

FIG. 7 is a view showing the clock wiring structure in the semiconductor integrated circuit device according to the second embodiment of this invention. In the first wiring structure 130 connecting the clock input 110 and the plurality of grid-like wiring structures 140 with equal wiring lengths, the outputs from the clock gating circuits 140 are connected to a region consisting of a plurality of grid-like wiring structures 150 so that the supply and stop of clocks to the plurality of grid-like wiring structures 150 are simultaneously gate-controlled.

For this reason, the positions where the clock gating circuits 140 are inserted in the first wiring structure are different from those in the first embodiment. Specifically, the clock gating circuits 140 are located on the symmetrically center line of the region 710. Their outputs are connected to the plurality of grid-like wiring structures 150 through the buffer gate(s) at a necessary number of stage(s).

More specifically, in the configuration of FIG. 4, the clock input 110 is connected to the clock gating circuits 140 through the buffer gates 120 at five stages and the output from the clock gating circuit is directly connected to the grid-like wiring structure 150. On the other hand, in the configuration of FIG. 7(a), the region 710 consists of two grid-like wiring structures 150 and the clock input 110 is connected to the clock gating circuits 140 through the buffer gates 120 at four stages and the output from the clock gating circuit is connected to the grid-like wiring structure 150 through the buffer gate 120 at one stage.

Likewise, in the configuration of FIG. 7(b), the region 710 consists of four grid-like wiring structures 150. The clock input 110 is connected to the clock gating circuits 140 through the buffer gates 120 at three stages, and the output from the clock gating circuit 140 is connected to the grid-like wiring structure 150 through the buffer gates 120 at two stages.

Likewise, in the configuration of FIG. 7(c), the region 710 consists of eight grid-like wiring structures 150. The clock input 110 is connected to the clock gating circuits 140 through the buffer gates 120 at two stages, and the output from the clock gating circuit 140 is connected to the grid-like wiring structure 150 through the buffer gates 120 at three stages.

Further, in the configuration of FIG. 7(d), like FIG. 7(b), the region 710 consists of four grid-like wiring structures 150, but on the wiring path of the first wiring structure 130, the clock gating circuits at two stages are inserted.

As described above, in accordance with this embodiment, for the region consisting of the plurality of grid-like wiring structures, the supply and stop of the clock by the clock gating circuit are gate-controlled. For this reason, power consumption can be more greatly reduced than the case where the clock gating circuit 140 is prepared for each of all the grid-like wiring structures 150.

By using the clock gating circuits at a plurality of stages,

the supply and stop of hierarchical clocks can be controlled so that using the clock gating circuits 140 at an appropriate number of stages, the power consumption can be reduced more effectively.

In this embodiment also, actually, the semiconductor integrated circuit device generally consists of a plurality of function modules. In this case also, if the circuit region of each function module is constructed of an arrangement of unit regions each having the grid-like wiring structure with the same shape in their clock wiring structure, by adopting the above first wiring structure, the effect of this embodiment can be obtained.

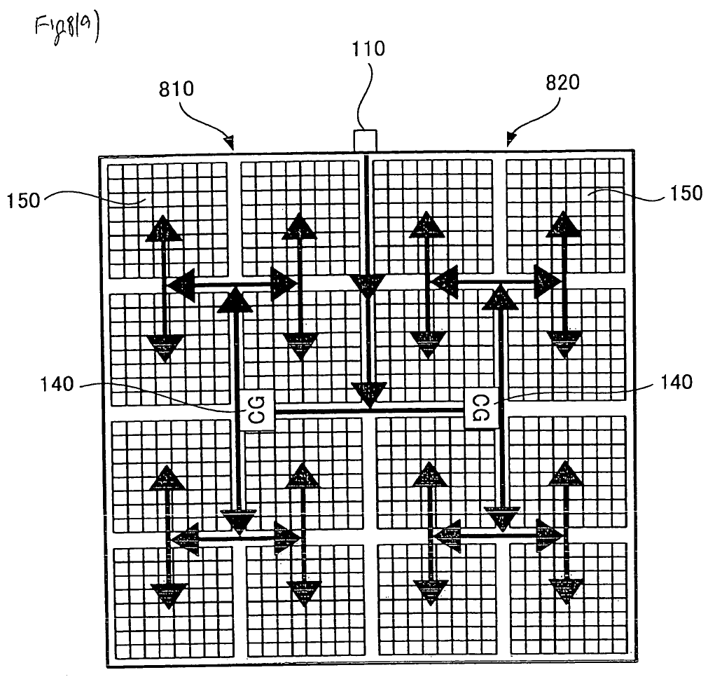

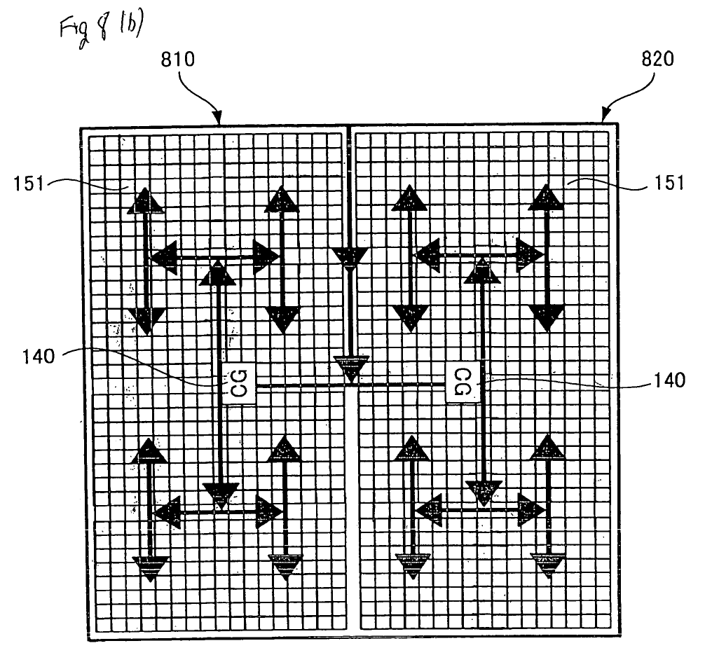

FIG. 8 is a view showing an application example of the wiring structure of this embodiment in the semiconductor integrated circuit device consisting of two function modules. In FIG. 8, reference numerals 810 and 820 denote the function module consisting of eight unit regions each having the grid-like wiring structure 150, respectively. For example, this application example is the semiconductor integrated circuit device in a multi-processor configuration having two similar processors.

The two function modules 810 and 820 are constructed of an arrangement of unit regions each having the grid-like wiring structure 150. Therefore, the entire wiring structure of the semiconductor integrated circuit device is the same as that in FIG. 7(c).

The supply and stop of the clock in each function module can be realized by the gate control by the clock control signal 230 in the clock gating circuits 140 in the grid-like wiring structures 150 of the unit regions constituting each function module.

Like the semiconductor integrated circuit device with the multi-processor, where the semiconductor integrated circuit device is provided with the substantially similar function modules, as shown in FIG. 8(b), in each of the function modules, a single extended grid-like wiring structure 151 composed of the eight connected grid-like wirings can be realized.

In this case, in the grid-like wiring structure 151 in each of the function modules, it is important to substantially keep the first wiring structure 130 and the grid-like wiring structure 150 as the clock wiring structure.

In the semiconductor integrated circuit device provided with the multi-processor, it is also important to reduce the clock skew both in each processor and between the processors. In accordance with the above technique, the clock skew between the processors can be minimized.

In accordance with this invention, also in the semiconductor integrated circuit device where the function modules or controlled regions having various sizes are mixed, the connection by the first wiring structure with substantially equal wiring lengths can be easily realized so that the clock skew can be minimized. Further, since the supply/stop of the clock signal can be optionally controlled by gate-controlling the clock gating circuit, the power consumption by the clock signal can be reduced. Thus, this invention is useful as the techniques for minimizing the clock skew and realizing the low power consumption.

What is claimed is:

1. A semiconductor integrated circuit device comprising:
a plurality of grid-like wiring structures arranged as unit regions in an entire circuit area and having the same shape as clock wiring structures, respectively;
a first wiring structure in which the wiring paths from a single clock input to the respective grid-like wiring structures are connected with substantially equal lengths and a common circuit or circuits with the same kind and the same number of stages are inserted in the same order in the respective wiring paths; and
a second wiring structure connecting a clock synchronizing circuit such as a flip-flop to each the grid-like wiring structures with the shortest length in each unit region, wherein
the circuits inserted in said first wiring structure include at least one stage of buffer circuit and at least one stage of clock gating circuit whose clock is gate-controlled by a clock control signal.

2. The semiconductor integrated circuit device according to claim 1, wherein said first wiring structure is an equal-length branched wiring structure with H-shapes.

3. The semiconductor integrated circuit device according to claim 1, wherein said clock control signal is given for each of the unit regions, for each of regions each composed of said plurality of unit regions, or each of function modules each composed of said plurality of unit regions.

4. The semiconductor integrated circuit device according to claim 1, wherein said clock gating circuit located at the final stage of the circuits inserted in said wiring structure gate-controls the clock for each of said unit regions.

5. The semiconductor integrated circuit device according to claim 1, wherein said clock gating circuit located at the final stage of the circuits inserted in said wiring structure gate-controls the clock simultaneously for said plurality of unit regions.

6. The semiconductor integrated circuit device according to claim 1, wherein said grid-like wiring structure has the same physical shape in all of said unit regions.
